(19) United States
(12) Patent Application Publication
(10) Pub. No.: US 2021/0343997 A1
(43) Pub. Date: Nov. 4, 2021

(54) PRIMARY BATTERY

(71) Applicant: Panasonic Intellectual Property Management Co., Ltd., Osaka (JP)

(72) Inventors: GO TEI, Osaka (JP); KOICHI SAWADA, Hyogo (JP); MITSUHIRO HIBINO, Kyoto (JP); MASAKO YOKOYAMA, Osaka (JP); MASAHISA FUJIMOTO, Osaka (JP); YU OTSUKA, Osaka (JP)

(21) Appl. No.: 17/377,429

(22) Filed: Jul. 16, 2021

Related U.S. Application Data
(63) Continuation of application No. PCT/JP2019/051323, filed on Dec. 26, 2019.

(30) Foreign Application Priority Data
Jun. 10, 2019 (JP) 2019-108234

(51) Int. Cl. H01M 4/06; H01M 4/131; H01M 4/48; H01M 6/18

(52) U.S. Cl. CPC H01M 4/06; H01M 4/131; H01M 2004/027; H01M 6/185; H01M 4/483

(57) ABSTRACT

A primary battery includes: a positive electrode including a positive electrode collector composed of a porous conductor, and a porous positive electrode layer disposed on the positive electrode collector, oxygen taken from outside of the primary battery through the positive electrode collector being allowed to diffuse into the porous positive electrode layer; a negative electrode including a negative electrode collector composed of a porous conductor, and a porous negative electrode layer disposed on the negative electrode collector, the porous negative electrode layer including lithium nitride composed of lithium and nitrogen, nitrogen generated during discharge being allowed to diffuse into the porous negative electrode layer; and a nonaqueous electrolytic solution disposed between the positive electrode and the negative electrode, the nonaqueous electrolytic solution containing a lithium salt.

### BACKGROUND

### 1. Technical Field

The present disclosure relates to a primary battery.

### 2. Description of the Related Art

In accordance with the expansion of the portable electronic equipment market, weight reduction and space savings of a battery mounted in such equipment have become increasingly more important, Lithium-air batteries and zinc-air batteries are known as batteries that realize weight reduction and space savings of the positive electrode of the battery by using oxygen in the air as a positive electrode active material.

For example, Japanese Patent No. 5023936 discloses a lithium-air battery in which oxygen is used as a positive electrode active material and lithium metal is used as a negative electrode. In this regard, a zinc-air battery in which oxygen is used as a positive electrode active material and zinc metal is used as a negative electrode is now in practical use. Since such batteries use oxygen in the air as the positive electrode active material, the batteries contain no solid positive electrode active material, such as a transition metal oxide or the like, and accordingly, weight reduction and space savings are expected.

### SUMMARY

One non-limiting and exemplary embodiment provides a primary battery having an improved volume capacity density and an improved electromotive force.

In one general aspect, the techniques disclosed here feature a primary battery including a positive electrode including a porous conductor, a negative electrode including a porous conductor and lithium nitride, and an electrolyte interposed between the positive electrode and the negative electrode.

The present disclosure provides a primary battery having an improved volume capacity density and an improved electromotive force.

Additional benefits and advantages of the disclosed embodiments will become apparent from the specification and drawings. The benefits and/or advantages may be individually obtained by the various embodiments and features of the specification and drawings, which need not all be provided to obtain one or more of such benefits and/or advantages.

### BRIEF DESCRIPTION OF THE DRAWINGS

FIG. 1 is a schematic sectional view illustrating a configuration example of a primary battery according to an embodiment of the present disclosure;

FIG. 2 is a schematic sectional view of an evaluation battery used in Example and

FIG. 3 illustrates a change in the current passing through a positive electrode over time during constant-potential discharge evaluation in Example 1.

### DETAILED DESCRIPTION

### Embodiment According to Disclosure

The embodiment according to the present disclosure will be described below in detail with reference to the drawings. In this regard, the embodiment below is an exemplification, and the present disclosure is not limited to the following embodiment.

The primary battery according to the present embodiment includes a positive electrode and a negative electrode, The positive electrode is configured to use oxygen (for example, oxygen in the air) as a positive electrode active material. That is, the positive electrode is a gas-diffusion electrode into which oxygen (for example, oxygen in the air) can diffuse and has, for example, a porous structure. The negative electrode has, for example, a porous structure and is a gas-diffusion electrode in which lithium nitride (for example, Li₃N, Li₂N₂, or LiN₃) is used as a negative electrode active material and into which nitrogen generated due to discharge can diffuse. The primary battery according to the present embodiment further includes an electrolyte disposed between the positive electrode and the negative electrode.

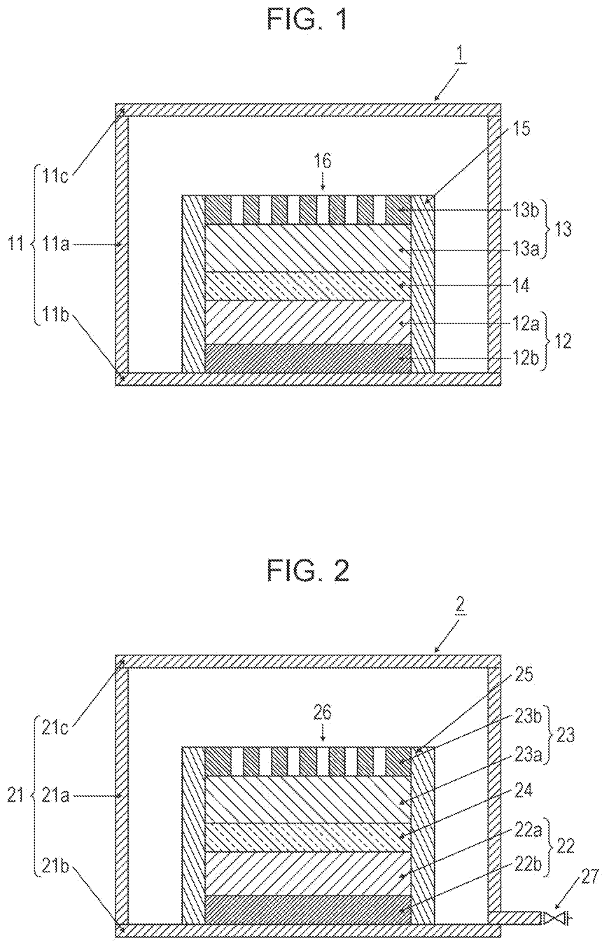

FIG. 1 is a schematic sectional view illustrating a configuration example of the primary battery according to the present disclosure. Hereafter, a primary battery according to an embodiment of the present disclosure is also referred to as a “nitrogen-oxygen battery”.

The nitrogen-oxygen battery 1 illustrated in FIG. 1 includes a battery case 11, a negative electrode 12, a positive electrode 13, and a nonaqueous electrolytic solution 14. The nonaqueous electrolytic solution 14 is disposed between the negative electrode 12 and the positive electrode 13. The battery case 11 includes a tubular portion 11 a in which both the top and the bottom are open, a bottom portion 11b disposed so as to block the bottom opening of the tubular portion 11a, and a lid portion 110 disposed so as to block the top opening of the tubular portion 11a. In this regard, although not illustrated in the drawing, the battery case 11 is configured to enable oxygen (for example, oxygen in the air) to enter the interior. For example, the lid portion 11c may have an air inlet hole to enable air to enter the interior of the battery case 11. The negative electrode 12 includes a negative electrode layer 12a and a negative electrode collector 12b. The negative electrode layer 12a is arranged between the negative electrode collector 12b and the nonaqueous electrolytic solution 14. The positive electrode 13 includes a positive electrode layer 13a and a positive electrode collector 13b. The positive electrode layer 13a is arranged between the positive electrode collector 13b and the nonaqueous electrolytic solution 14. A frame body 15 is disposed on the side surface of a multilayer body including the negative electrode 12, the nonaqueous electrolytic solution 14, and the positive electrode 13. Although not illustrated in the drawing, the nitrogen-oxygen battery 1 may further include a separator contained in the nonaqueous electrolytic solution 14.

The positive electrode layer 13a of the positive electrode 13 is configured to use oxygen (for example, oxygen in the air) as a positive electrode active material. That is, the positive electrode layer 13a has a gas-diffusion structure into which oxygen (for example, oxygen in the air) can diffuse. The positive electrode layer 13a has, for example, a porous structure serving as the gas-diffusion structure. The positive electrode collector 13b may have air inlet holes 16, as illustrated in FIG. 1, to enable oxygen (for example, oxygen in the air) to enter the positive electrode layer 13a.

The negative electrode layer 12a of the negative electrode 12 has a negative electrode active material including lithium nitride (for example, Li₃N, Li₂N₂, or LiN₃). The negative electrode layer 12a has a gas-diffusion structure into which nitrogen generated due to discharge can diffuse. The negative electrode layer 12a has, for example, a porous structure serving as the gas-diffusion structure.

The positive electrode includes a diffusion electrode into which oxygen serving as the positive electrode active material can diffuse. The lithium nitride contained in the negative electrode may be at least one selected from the group consisting of Li₃N, Li₂N₂, and LiN₃.

For example, when the lithium nitride contained in the negative electrode of the nitrogen-oxygen battery according to the present embodiment is Li₃N, and the lithium oxide generated due to discharge in the positive electrode is Li₂O₂, the battery reaction is as described below.
Discharge reaction

negative electrode: 2Li₃N→N₂+6Li⁺+6e⁻ (1)

positive electrode: 6Li⁺+6e⁻+3O₂→3Li₂O₂ (2)

As illustrated in Formulae (1) and (2), during discharge, the discharge product of the negative electrode is nitrogen, whereas in the positive electrode, electrons are taken up and, simultaneously, oxygen entering the battery from the outside reacts with lithium ions so as to produce a lithium oxide,

In the primary battery according to the present embodiment, when the negative electrode 12 contains Li₃N as the lithium nitride, the theoretical volume capacity density of the primary battery according to the present embodiment is 2,931 mAh/cc whereas the theoretical volume capacity density of a lithium-air secondary battery is 2,061 mAh/cc. Therefore, a higher theoretical volume capacity density can be realized.

A zinc-air battery has a high theoretical volume capacity density (5,855 mAh/cc) but has problems such as a low theoretical electromotive force (1.65 V) and a reduced operating life due to a reaction between an alkaline electrolytic solution constituting the battery and carbon dioxide in the air Such problems are intrinsic to batteries including an aqueous electrolytic solution. On the other hand, the primary battery using a nonaqueous electrolytic solution according to a first aspect can address such problems as a result of having a high theoretical electromotive force (2.52 V) and using a nonaqueous electrolytic solution.

Each configuration of such a nitrogen-oxygen battery will be described below in detail.

### 1. Positive Electrode

As described above, the positive electrode may include a positive electrode layer and a positive electrode collector. Each of the positive electrode layer and the positive electrode collector will be described below.

### (1) Positive Electrode Layer

The positive electrode layer contains a material that enables oxygen to be reduced where the oxygen (for example, oxygen in the air) serves as a positive electrode active material. Regarding such a material the positive electrode layer according to the present disclosure contains, for example, a conductive porous body containing carbon. A carbon material used as the conductive porous body containing carbon may have high electron conductivity. Specifically, common carbon materials such as acetylene black and Ketjenblack, which are used as a conductive auxiliary agent, are used. Of these carbon materials, from the viewpoint of specific surface area, a conductive carbon black such as Ketjenblack may be used in combination. In this regard, acetylene black may be mixed with Ketjenblack.

The positive electrode layer containing the above-described carbon material may contain a binder. Regarding the binder, materials known as binders for a positive electrode layer may be used, and examples include polyvinylidene fluoride (PVdF) and polytetrafluoroethylene (PTFE). There is no particular limitation regarding the content of the binder in the positive electrode layer. The content of the binder in the positive electrode layer may be within the range of, for example, greater than or equal to 1% by mass and less than or equal to 40% by mass.

The positive electrode layer may contain a catalyst material for the purpose of facilitating redox of oxygen in the positive electrode layer. Examples of the catalyst material include:
(i) platinum compounds such as platinum, platinum alloys, and platinum oxides
(ii) ruthenium compounds such as ruthenium, ruthenium alloys, and ruthenium oxides
(iii) iridium compounds such as iridium, iridium alloys, and iridium oxides
(iv) transition metals such as titanium, vanadium, chromium, manganese, iron, cobalt, nickel, copper, zinc, gallium, and germanium and transition metal alloys
(v) transition metal compounds such as transition metal oxides

There is no particular limitation regarding the thickness of the positive electrode layer since the thickness differs in accordance with the use or the like of the nitrogen-oxygen battery. The thickness of the positive electrode layer may be set to be within the range of, for example, greater than or equal to 2 μm and less than or equal to 500 μm and may be set to be within the range of greater than or equal to 5 μm and less than or equal to 300 μm.

Regarding the method for forming the positive electrode layer, for example, the following method may be used. For example, a paint in which a raw material for a porous body constituting the positive electrode layer, a binder, and a sublimable powder are dispersed in a solvent is produced, and the paint is made into a film. The resulting film is heat-treated so as to remove the sublimable powder and the solvent. As a result, a porous film with pores of a predetermined diameter is formed. The positive electrode layer may be produced by disposing the porous film on a positive electrode collector, described below, by using, for example, a contact-bonding method. The sublimable powder functions as a pore-forming agent. Therefore, the porous film produced by using the sublimable powder, as described above, can realize a predetermined pore structure.

### (2) Positive Electrode Collector

The positive electrode collector performs current collection for the positive electrode layer. Therefore, there is no particular limitation regarding the material for forming the positive electrode collector provided that the material has conductivity. Known materials for forming positive electrode collectors of common primary batteries may be used as the material for forming the positive electrode collector. Examples of the material for forming the positive electrode collector include stainless steel, nickel, aluminum, iron, titanium, and carbon. Regarding the form of the positive electrode collector according to the present embodiment, the collector in the form of, for example, foil, a plate, or a mesh (grid) needs to have a columnar protrusion portion to stick and fix the positive electrode layer containing carbon. Examples of the method for forming the collector include a photoetching method. In the present embodiment, the base portion of the protrusion portion of the positive electrode collector may be in the form of a mesh since the positive electrode collector, part of which is in the form of a mesh, has excellent current collection efficiency and an excellent capability of supplying oxygen. In such an instance, the positive electrode layer is typically arranged so as to be stuck by the protrusion portion disposed on the mesh portion of the positive electrode collector. Further, the length of the protrusion portion may be greater than or equal to the thickness of the porous body since numerous pores of the porous body can be maintained while current collection is reliably performed. This is because a reaction area can be increased by improving the current collection efficiency while the volume of the porous body that is eliminated due to sticking by the protrusion portion is decreased. The nitrogen-oxygen battery according to the present embodiment may further include another positive electrode collector (for example, a foil-like collector) to collect the electric charge collected by a mesh-like positive electrode collector. In the present embodiment, a battery case described later may also have the function of the positive electrode collector,

The thickness of the positive electrode collector may be set to be within the range of, for example, greater than or equal to 10 μm and less than or equal to 1,000 μm and may be within the range of greater than or equal to 20 μm and less than or equal to 400 μm.

### 2. Negative Electrode

As described above, the negative electrode includes a negative electrode layer and may further include a negative electrode collector. Each of the negative electrode layer and the negative electrode collector will be described below.

### (1) Negative Electrode Layer

The negative electrode layer includes a gas-diffusion electrode containing lithium nitride (for example, Li₃N, Li₂N₂, or LiN₃). Regarding such a material, the negative electrode layer according to the present embodiment includes, a carbon-containing conductive porous body that carries, for example, Li₃N. The carbon material used as the carbon-containing conductive porous body may have high electron conductivity. Specifically, common carbon materials such as acetylene black and Ketjenblack, which are used as a conductive auxiliary agent, may be used. Of these carbon materials, from the viewpoint of specific surface area, a conductive carbon black such as Ketjenblack may be used in combination. In this regard, acetylene black may be mixed with Ketjenblack.

The negative electrode layer containing the above-described carbon material may contain a binder. Regarding the binder, materials known as binders for a negative electrode layer may be used, and examples include polyvinylidene fluoride (PVdF) and polytetrafluoroethylene (PTFE). There is no particular limitation regarding the content of the binder in the negative electrode layer. The content of the binder in the negative electrode layer may be within the range of, for example, greater than or equal to 1% by mass and less than or equal to 40% by mass.

The negative electrode layer may contain a catalyst material for the purpose of facilitating oxidation of lithium nitride in the negative electrode layer.

Examples of the catalyst material include:
(i) platinum compounds such as platinum, platinum alloys, and platinum oxides
(ii) ruthenium compounds such as ruthenium, ruthenium alloys, and ruthenium oxides
(iii) iridium compounds such as iridium, iridium alloys, and iridium oxides
(iv) transition metals such as titanium, vanadium, chromium, manganese, iron, cobalt, nickel, copper, zinc, gallium, and germanium and transition metal alloys
(v) transition metal compounds such as transition metal oxides

There is no particular limitation regarding the thickness of the negative electrode layer since the thickness differs in accordance with the use or the like of the nitrogen-oxygen battery. The thickness of the negative electrode layer may be set to be within the range of, for example, greater than or equal to 2 μm and less than or equal to 500 μm and may be set to be within the range of 5 μm and less than or equal to 300 μm.

As an example of the method for forming the negative electrode layer, the following method may be used. For example, a paint in which a raw material for a porous body constituting the negative electrode layer, a binder, and a sublimable powder are dispersed in a solvent is produced, and the paint is made into a film. The resulting film is heat-treated so as to remove the sublimable powder and the solvent, As a result, a porous film with pores of a predetermined diameter is formed. The negative electrode layer may be produced by disposing the porous film on a negative electrode collector, described below, by using, for example, a contact-bonding method. The sublimable powder functions as a pore-forming agent. Therefore, the porous film produced by using the sublimable powder, as described above, can realize a predetermined porous structure.

### (2) Negative Electrode Collector

The negative electrode collector performs current collection for the negative electrode layer. Therefore, there is no particular limitation regarding the material for forming the negative electrode collector provided that the material has conductivity. Known materials for forming negative electrode collectors of common primary batteries may be used as the material for forming the negative electrode collector. Examples of the material for forming the negative electrode collector include stainless steel, nickel, aluminum, iron, titanium, and carbon. Regarding the form of the negative electrode collector according to the present embodiment, the collector in the form of, for example, foil, a plate, or a mesh (grid) may have a columnar protrusion portion to stick and fix the positive electrode layer containing carbon. Examples of the method for forming the collector include a photoetching method. In the present embodiment, the base portion of the protrusion portion of the negative electrode collector may be in the form of a mesh since the negative electrode collector, part of which is in the form of a mesh, has excellent current collection efficiency and an excellent capability of supplying oxygen. In such an instance, the negative electrode layer is typically arranged so as to be stuck by the protrusion portion disposed on the mesh portion of the negative electrode collector. Further, the length of the protrusion portion may be greater than or equal to the thickness of the negative electrode layer since numerous pores of the porous body constituting the negative electrode layer can be maintained while current collection is reliably performed. This is because a reaction area can be increased by improving the current collection efficiency while the volume of the porous body that is eliminated due to sticking by the protrusion portion is decreased, The nitrogen-oxygen battery according to the present embodiment may further include another negative electrode collector (for example, a foil-like collector) to collect the electric charge collected by a mesh-like negative electrode collector. In the present embodiment, a battery case described later may also have the function of the negative electrode collector.

The thickness of the negative electrode collector may be set to be within the range of, for example, greater than or equal to 10 μm and less than or equal to 1,000 μm and may be within the range of greater than or equal to 20 μm and less than or equal to 400 μm.

### 3. Separator

The nitrogen-oxygen battery according to the present embodiment may include a separator arranged between the positive electrode and the negative electrode. The separator being arranged between the positive electrode and the negative electrode enables a battery having high safety to be obtained. There is no particular limitation regarding the separator provided that the separator has a function of electrically separating the positive electrode layer from the negative electrode layer. Regarding the separator, porous insulating materials, for example, porous films of polyethylene (PE), polypropylene (PP), or the like, resin nonwoven fabrics of PE, PP, or the like, glass fiber nonwoven fabrics, and paper nonwoven fabrics, may be used.

The porosity of the separator may be greater than or equal to 30% and less than or equal to 90%. The porosity of the separator being greater than or equal to 30% enables the separator to sufficiently retain an electrolyte when the electrolyte is retained by the separator. The porosity being less than or equal to 90% enables sufficient separator strength to be acquired. The porosity of the separator may be within the range of greater than or equal to 35% and less than or equal to 60%.

The separator may be arranged in the electrolyte. When the positive electrode collector is provided with a plurality of protrusion portions, at least some of the plurality of protrusion portions may be in contact with the separator.

### 4. Electrolyte

The electrolyte is disposed between the positive electrode and the negative electrode and conducts lithium ions. Therefore, there is no particular limitation regarding the form of the electrolyte provided that the electrolyte is a material having lithium ion conductivity (that is, a lithium ion conductor). The form of the electrolyte may be any one of a solution represented by an organic solvent containing a lithium salt or a solid film represented by a polymeric solid electrolyte containing a lithium salt.

When the form of the electrolyte is a solution, for example, a nonaqueous electrolytic solution prepared by dissolving a lithium salt in a nonaqueous solvent may be used.

Examples of the lithium salt contained as the electrolyte in the nonaqueous electrolytic solution include lithium perchlorate (LiClO₄), hexafluorophosphate (LiPFe), lithium tetrafluoroborate (LiBF₄), lithium trifluoromethanesulfonate (LiCF₃SO₃), and lithium bis(trifluoromethanesulfonyl)amide (LiN(CF₃SO₂)₂). However, the lithium salt is not limited to these. Regarding the lithium salt, lithium salts known as electrolytes of nonaqueous electrolytic solutions for lithium ion batteries may be used.

The amount of the electrolyte dissolved in the nonaqueous solvent is, for example, greater than or equal to 0.5 mol/L and less than or equal to 2.5 mol/L. When the electrolyte of the form of the solution (for example, a nonaqueous electrolytic solution) is used, as described above, the electrolyte may be formed by impregnating the separator with the nonaqueous electrolytic solution to be retained.

Regarding the nonaqueous solvent, nonaqueous solvents known as nonaqueous solvents of nonaqueous electrolytic solutions for lithium ion batteries may be used. Of these, chain ethers such as tetraethylene glycol dimethyl ether may be used as the solvent because, in chain-ether-based solvents, a side reaction other than a redox reaction of oxygen does not readily occur in the positive electrode compared with carbonate-based solvents.

The nonaqueous solvent may contain at least one additives for the purpose of increasing the solubility of oxygen and/or nitrogen. Examples of the additive include tris(2,2,2-trifluoroethyl)phosphite, tris(2,2,2-trifluoroethyl)borate, tris(2,2,2-trifluoroethyl)phosphate, tris(2,2,2-trifluoroethyl)orthoformate, tris(1,1,1,3,3,3-hexafluoro-2-propyl)phosphite, tris(hexafluoroisopropyl)borate, tris(pentafluorophenyl)borate, tris(pentafluorophenyl)phosphine, methyl nonafluorobutyl ether, 1,1,2,2-tetrafluoroethyl 2,2,3,3-tetrafluoropropyl ether, 1,2-(1,1,2,2-tetrafluoroethoxyl)ethane, and 1,1,1,2,2,3,3,4,4-nonafluoro-6-propoxy-hexane.

### 5. Battery Case

There is no particular limitation regarding the battery case of the nitrogen-oxygen battery according to the present embodiment provided that the above-described positive electrode, negative electrode, and electrolyte can be housed. Therefore, the battery case of the nitrogen-oxygen battery according to the present embodiment is not limited to the battery case 11 illustrated in FIG. 1. Regarding the nitrogen-oxygen battery according to the present embodiment, cases for batteries of various types, such as a coin type, a flat type, a cylindrical type, and a laminate type, may be used. The battery case may be an open-air-type battery case or a closed-type battery case. In this regard, the open-air-type battery case is a case which has a vent for air to enter and exit so as to expose the positive electrode to air. On the other hand, when using the closed battery case, the closed battery case may be provided with a supply tube and a discharge tube for gas (for example, air). In such an instance, the gas to be supplied or discharged may be a dry gas. The above-described gas may have a high oxygen concentration or may be pure oxygen (99.9999%).

### EXAMPLES

The present disclosure will be described below in further detail with reference to the examples, In this regard, the following examples are exemplifications, and the present disclosure is not limited to the following examples.

### Example 1

In Example 1, the open-end voltage and the discharge characteristics of the nitrogen-oxygen battery according to the present disclosure were evaluated.

FIG. 2 is a schematic sectional view of an evaluation battery used in Example 1. The evaluation battery 2 included a battery case 21, a negative electrode 22, a positive electrode 23, and an electrolyte 24. A frame body 25 was disposed on the side surface of a multilayer body including the negative electrode 22, the electrolyte 24, and the positive electrode 23. The battery case 21 included a tubular portion 21a, a bottom portion 21b disposed on the bottom of the tubular portion 21a, and a lid portion 21c on the top of the tubular portion 21a. In addition, the battery case 21 included a valve 27 for controlling the atmosphere inside the battery case 21.

The negative electrode 22 included a negative electrode layer 22a and a negative electrode collector 22b. The negative electrode 22 was arranged on the inner bottom surface of the bottom portion 21b of the battery case 21. The negative electrode collector 22b of the negative electrode 22 was in contact with the inner bottom surface of the bottom portion 21b of the battery case 21.

The positive electrode 23 included a positive electrode layer 23a and a positive electrode collector 23b, The positive electrode layer 23a was arranged between the positive electrode collector 23b and the electrolyte 24. The positive electrode collector 23b was provided with oxygen inlet holes 26.

Although not illustrated in the drawing, the evaluation battery 2 included a separator contained in the electrolyte 24.

The evaluation battery 2 was produced as described below.

### Positive Electrode

Regarding the material for forming a conductive porous body containing carbon, “Ketjenblack EC 600JD” produced by Lion Specialty Chemicals Co., Ltd., “Acetylene Black HS100-L” produced by Denka Company Limited, and “CNovel P(3)10” produced by TOY° TANSO CO., LTD. were used. Powders of these carbon materials, a surfactant solution “Newcol 1308-FA(90)” produced by NIPPON NYUKAZAI CO., LTD., and “Fumaric Acid” which is produced by NIPPON SHOKUBAI CO., LTD. and which serves as a sublimable powder responsible for functioning as a pore-forming agent were mixed and agitated so as to obtain a mixture. In this regard, the fumaric acid was pulverized into a powder by using a jet mill in advance and was used as the sublimable powder. The mass ratio of “Ketjenblack EC 600JD”, “Acetylene Black HS100-L”, and “CNovel P(3)10” was 2:2:3 in this order. The resulting mixture was cooled. Thereafter, “FluonR PTFE AD AD911E” which is produced by ASAHI GLASS CO., LTD. and which serves as a binder was added to the resulting mixture, and agitation was performed again. The binder was added so that the mass ratio of the carbon material (that is, a total of “Ketjenblack EC 600JD”, “Acetylene Black HS100-L”, and “CNovel P(3)10”) to the binder was set to be 7:3. The resulting mixture was rolled by roll press so as to produce a sheet. The resulting sheet was heat-treated at 320° C. in a heat treatment furnace so as to remove moisture, the surfactant, and the sublimable powder. The sheet was rolled again by a roll press to adjust the thickness to 200 μm so as to obtain the positive electrode layer 23a.

Regarding the positive electrode collector 23b, an SUS 316 structure including a mesh-like collector and a plurality of protrusion portions arranged on the mesh surface of the mesh-like collector was produced. The protrusion portions extended in the direction perpendicular to the mesh surface of the mesh-like collector. The protrusion portion was a column having a height of 200 μm and a circular bottom surface with a diameter of 200 μm. The plurality of protrusion portions were arranged at an interval of 1,200 between protrusion portions. The opening portions of the mesh-like collector constituted the oxygen introduction portions 26.

The positive electrode collector 23b was attached to the positive electrode layer 23a so that the surface provided with the protrusion portions was in contact with the positive electrode layer 23a. In this manner, the positive electrode 23 was obtained.

### Negative Electrode

Mixing of 11.72 mg of Li₃N, 11.72 mg of acetylene black (“Acetylene Black HS100-L” produced by Denka Company Limited), and 5.86 mg of PTFE was performed, and pulverization and mixing were performed by using an agate mortar. The obtained mixture was used as a negative electrode mix.

A structure having the same configuration as the positive electrode collector 23b was used as the negative electrode collector 22b. The negative electrode layer 22a having a thickness of 233 μm was formed on the surface provided with the protrusion portions of the negative electrode collector 22b by using the above-described negative electrode mix. In this manner, the negative electrode 22 was obtained.

### Electrolyte

A nonaqueous electrolytic solution was used as the electrolyte 24. Regarding the nonaqueous electrolytic solution, a solution in which lithium bis(trifluoromethanesulfonyl)amide (LiTFSA produced by KISHIDA CHEMICAL Co., Ltd.) serving as a lithium salt was dissolved in tetraethylene glycol dimethyl ether (TEGDME produced by KISHIDA CHEMICAL Co., Ltd.) serving as a nonaqueous solvent was used. This nonaqueous electrolytic solution was obtained by adding LiTFSA to TEGDME so that the concentration became 1 mol/L and by agitating the solution overnight in a dry air atmosphere at a dew point of lower than or equal to −50° C. so as to perform mixing and dissolution.

### Production of Evaluation Battery

The evaluation battery 2 was produced by using the positive electrode 23, the negative electrode 22, and the electrolyte 24 described above. In this regard, a glass fiber separator was used as the separator. The positive electrode 23 (that is, the positive electrode layer 23a and the positive electrode collector 23b), the separator (not illustrated in the drawing), the electrolyte 24, and the negative electrode 22 (that is, the negative electrode layer 22a and the negative electrode collector 22b) were arranged as illustrated in FIG. 2 so as to produce the evaluation battery 2. Air was supplied into the battery case 21 through the valve 27 to fill the interior of the battery case 21 with air. The air that filled the battery case 21 was dried so that the dew point became lower than or equal to −60° C. The interior of the battery case 21 was sealed by closing the valve 27,

### Evaluation Test

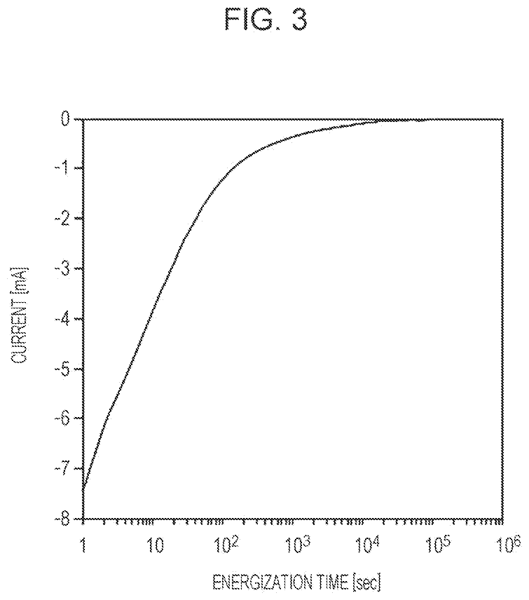

The open-end voltage of the evaluation battery of Example 1 was 2.13 V. The potential of the positive electrode 23 relative to the negative electrode 22 was set to be 0.1 V, and the integrated value of charge that passes from the negative electrode 22 to the positive electrode 23 was measured (constant-potential discharge evaluation). As a result, the discharge volume capacity density of Li₃N was 189 mAh/cc. FIG. 3 is a diagram illustrating a change in the current passing through the positive electrode over time during the above-described constant-potential discharge evaluation. In FIG. 3, the horizontal axis represents the energization period during which the current was passed through the positive electrode, and the vertical axis represents the current passed through the positive electrode.

As is clear from the result described above, regarding the primary battery according to the present embodiment, it was demonstrated that the nitrogen-oxygen battery expected to have a high discharge volume capacity density was able to actually discharge through a reduction reaction of oxygen for the positive electrode and through an oxidation reaction of lithium nitride for the negative electrode.

In addition, regarding the primary battery according to the present embodiment, the open-end voltage (battery voltage) of 2.13 V was obtained, and it was demonstrated that a battery voltage higher than the theoretical electromotive force of the zinc-air battery of 1.65 V was obtained.

What is claimed is:

1. A primary battery comprising:
a positive electrode including
a positive electrode collector composed of a porous conductor, and
a porous positive electrode layer disposed on the positive electrode collector, oxygen taken from outside of the primary battery through the positive electrode collector being allowed to diffuse into the porous positive electrode layer;
a negative electrode including
a negative electrode collector composed of a porous conductor, and
a porous negative electrode layer disposed on the negative electrode collector, the porous negative electrode layer including lithium nitride composed of lithium and nitrogen, nitrogen generated during discharge being allowed to diffuse into the porous negative electrode layer; and
a nonaqueous electrolytic solution disposed between the positive electrode and the negative electrode, the nonaqueous electrolytic solution containing a lithium salt.

2. The primary battery according to claim 1, wherein the lithium nitride is at least one selected from the group consisting of Li₃N, Li₂N₂, and LiN₃.

3. The primary battery according to claim 1, wherein the lithium nitride is Li₃N.
